(19) United States
(12) Patent Application Publication
(10) Pub. No.: US 2010/0045595 A1
(43) Pub. Date: Feb. 25, 2010

(54) SYSTEM AND METHOD FOR CONTROLLING A DISPLAYED PRESENTATION, SUCH AS A SEXUALLY EXPLICIT PRESENTATION

(76) Inventor: Erik Bakke, Seattle, WA (US)

Correspondence Address: PERKINS COIE LLP;PATENT-SEA, P.O. BOX 1247, SEATTLE, WA, 98111-1247, US

(21) Appl. No.: 12/517,044

(22) PCT Filed: Nov. 29, 2007
(86) PCT No.: PCT/US07/85970

§ 371 Date: May 29, 2009

Related U.S. Application Data
(60) Provisional application No. 60/872,017, filed on Nov. 29, 2006.

(51) Int. Cl. G09G 5/00

(52) U.S. Cl. 345/156

(57) ABSTRACT

A hand-held or hand-attached computer control device and associated system is utilized to control graphical objects in a computer-driven display in which the motion, type of behavior, and attributes of the graphical object are controlled through movement and resulting accelerations of the control device, such that the individual is provided with control during sexual self-stimulation.

### CROSS REFERENCE TO RELATED APPLICATIONS

This application claims the benefit of U.S. Provisional Patent Application No. 60/872,017, filed on Nov. 29, 2006, entitled SYSTEM AND METHOD FOR CONTROLLING ON-SCREEN CHARACTERS, SUCH AS FOR USE WITH ACCELERATION DEVICES, which is hereby incorporated by reference in its entirety.

### BACKGROUND

Typical video games allow a user to interact with and control an on-screen character using a mouse as an input device. For example, in order to select a character, a user may press a button on the mouse and drag the mouse in various directions while maintaining depression of the button. During interaction with the video game, the user may repeat such actions many times. Dragging a mouse back and forth may not be most intuitive method of controlling an on-screen character, such as during a video game or other interactive presentation that depicts acts of a sexual nature.

The hand motion required would be extremely repetitive and tiring for the user because using a mouse requires the user to maintain his/her hand on a substantially planar surface in order to properly use the mouse. The motion of the hand used to depress a mouse button while dragging the mouse in various directions across a planar surface may be the least ergonomic of all mouse motions. Additionally, prolonged and frequent performance of such a motion may lead to debilitating conditions for a user, such as carpal tunnel syndrome and repetitive stress injury.

These and other problems exist with respect to systems that provide interactive entertainment for a user.

### BRIEF DESCRIPTION OF THE DRAWINGS

FIG. 1A is a system diagram illustrating a user controlled entertainment system that provides user control of characters visually displayed to a user.

FIG. 1B is a block diagram of a basic and suitable computer that may employ aspects of the system.

FIG. 1C is a block diagram illustrating the system operating in a networked computer environment.

FIG. 2 is a block diagram illustrating components of a user controlled entertainment system.

FIG. 3 is a block diagram illustrating a user control device for use within the user controlled entertainment system.

FIG. 4 is a block diagram illustrating the user control device in greater detail.

FIG. 5 is a block diagram illustrating components of the motion estimation component.

FIG. 6 is a block diagram illustrating components of an alternative motion estimation component used by the computing device is shown.

FIG. 7 is a block diagram illustrating components of a character control component.

FIG. 8 is a table relating the position of a user hand, a corresponding parametric value for one axis of movement, and a displayed character frame.

FIG. 9 is a block diagram illustrating components of the hand motion tracking system.

FIG. 10 is a schematic diagram of the user control device attached to a male self-stimulation device.

FIG. 11 is a schematic diagram of the user control device attached to a female self-stimulation device.

FIG. 12 is a schematic diagram of the user control device embedded within a female self-stimulation device.

FIG. 13 is a schematic diagram of the user control device attached to a user's hand.

FIG. 14 is a schematic diagram of the user control device attached to a user's finger.

FIG. 15 is a schematic diagram of the user control device attached to a user's fingertip.

FIG. 16 is a schematic diagram of the user control device having a dynamic user input component.

### DETAILED DESCRIPTION

A system and method for controlling, via a hand-held or hand-attached device, the motion, behavior, and/or attributes of a visually displayed graphical object, icon, or character, such as a graphical object of a sexual nature, is described. For example, the system includes a device that tracks the motion of a hand of a user during sexual self-stimulation using one or more inertia-based or state based sensors (such as accelerometers), transmits information related to the tracked motion to a processing and/or controlling component, and controls a graphical object displayed to the user via a display component.

In some examples, the system provides for both females and males to control the visually displayed graphical object based on the motion of a user's hand during sexual self-stimulation. The system may include various configurations of the hand-held or hand-attached device in order to facilitate use for either a male or a female. Also, the system may include various configurations of the device in order to enhance the comfort and/or experience of the user. Thus, in some cases the system provides user control while minimizing encumbering hardware found in typical systems, enabling a user to perform the natural human motion of his/her hand during self-stimulation while also controlling the motion, behavior, and/or attributes of a viewed graphical object.

In some cases, the system employs a hand-attached device that attaches in a non-permanent manner to points on the user's wrist, hand, or finger. In these cases, the motion of the user's hand controls the on-screen object, character, or icon during self-stimulation. For example, internally-mounted, mutually orthogonal accelerometers are contained within the device. In some cases, the device is configured to be held in a user's hand. The device may be contained by or configured to resemble sexual stimulation devices, such as vibrators, dildos, and so on.

In some examples, the hand-held or hand-attached device includes a switch, pressure sensing button or other input component that can assist in receiving input from a user, such as input related to interaction with an on-screen character. For example, the device may include a button that is pressed or pinched by the user in order to effect additional behavioral adjustments when interacting with the on-screen character.

In some examples, the system measures acceleration in various directions to determine the motion of a user's hand. In some cases, the device measures the acceleration of the hand, converts the measured acceleration with an analog-to-digital converter to digital acceleration values and transmits the digital values to a computing device over a wired or wireless data communication link. The computing device (such as a controller that communicates with a monitor) receives the digital values and determines a parametric value for each axis of acceleration of the hand motion using one or more predetermined algorithms. The computing device may then alter on-screen objects presented to the user via the display device. For example, the computing device may adjust animation parameters, motion, type of behavior, and/or attributes, by inputting the parametric values into a set of predetermined algorithms.

For example, the computing device may use a determined parametric value, corresponding to motion of a user's hand, to pick a frame to display in a short sequence of animated frames that depict a character engaging in one cycle of a sexual action. As the user performs a cyclical motion of self stimulation with his hand, the displayed frame will change accordingly, substantially matching the character's motion with the motion of the user's hand. The displayed frame may be a pre-recorded two-dimensional set of static images, a three-dimensional character model animated and rendered in real time, and so on. Furthermore, the computing device may use the parametric values to alter an on-screen character's behavior, persona, emotions, and other quantifiable attributes.

In some cases, the computing device tracks the parametric values as signals in time. For example, the system may transform a time domain signal into a frequency domain signal, which provides a representation of the frequency of the user's hand motion as well as the intensity of the user's hand motion.

In some cases, the computing device monitors raw or filtered accelerometer measurements to determine minimum and maximum values during motion, which provides an estimated hand motion frequency and intensity. The system may use the estimated hand motion frequency to predict the position or inclination of the hand-held or hand-attached device. In these cases, the system may estimate or predict the motion of a user's hand in order to alter a displayed character's behavior.

In some cases, the system may calibrate and/or normalize the accelerometer measurements to the earth's gravitational field in order to convert the measurements to determine an inclination estimate of the hand-held or hand-attached device. The system may then use the inclination estimate to generate a parametric value for the hand motion.

Various examples of the system will now be described. The following description provides specific details for a thorough understanding and enabling description of these examples. One skilled in the art will understand, however, that the system may be practiced without many of these details. Additionally, some well-known structures or functions may not be shown or described in detail, so as to avoid unnecessarily obscuring the relevant description of the various examples.

The terminology used in the description presented below is intended to be interpreted in its broadest reasonable manner, even though it is being used in conjunction with a detailed description of certain specific embodiments of the system. Certain terms may even be emphasized below; however, any terminology intended to be interpreted in any restricted manner will be overtly and specifically defined as such in this Detailed Description section.

### Suitable System

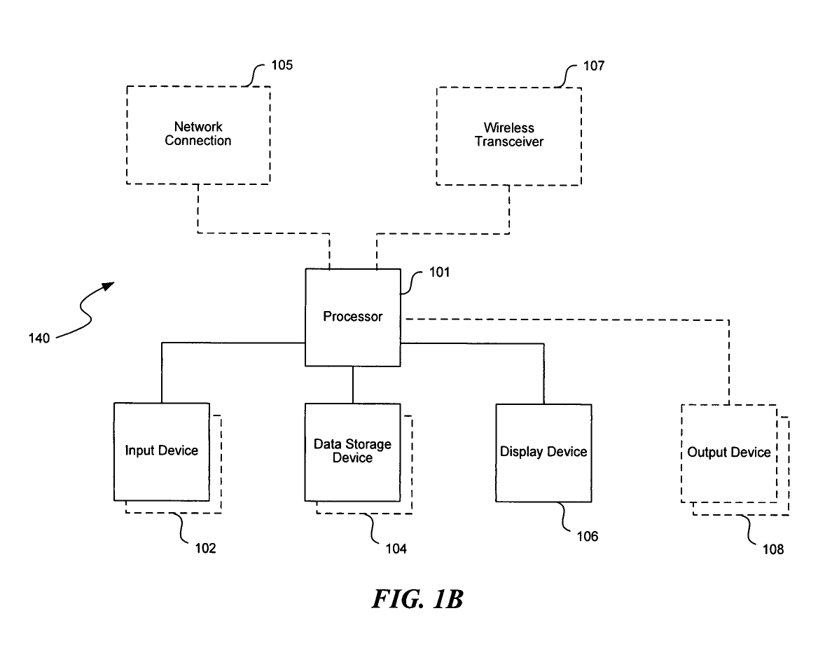

Referring to FIG. 1A, a system diagram illustrating a user controlled entertainment system 100 that provides user control of visually displayed characters is described. The term character is used throughout this description, and is meant to represent any person, icon, cursor, or object in a video game or simulation system. For example, a character can be a human female, a dildo, a couch, a bed, an animated object, any other object or displayed frame.

The user controlled entertainment system includes a computing system 120 having a display device 122 (such as a monitor) that presents a character 126 via a screen 124. In order to control the movement or behavior of the character 126, a control device 130 (shown attached to a user's hand at a point near the user's wrist 132) moves generally along the X, Y, and Z axes to control the displayed character 126. For example, during male self-stimulation (i.e., masturbation), a male user repetitively moves his hand 134 in relation to his penis 138, such as in direction F, which is more or less aligned with the X axis. Such movement and/or relative position to the user's penis may cause the character 126 to move, speak, and otherwise change behavior, as prompted by the movement of the control device 130.

Of course, computing system 120 is not limited to any specific type of computer system. For example, the computing system 120 may be a desktop computer, a laptop computer, or a tablet computer, a video game console system (such as a Sony Playstation 2, Microsoft XBox, or other video game console systems), a handheld portable gaming device (such as a Sony PSP), a mobile phone with graphical display capabilities, and so on. In fact, computing system 120 may be configured as a stand alone box that attaches to a display device and provides the described capabilities.

FIG. 1A and the following discussion provide a brief, general description of a suitable computing environment in which aspects of the system can be implemented. Although not required, aspects and embodiments of the system will be described in the general context of computer-executable instructions, such as routines executed by a general-purpose computer, e.g., a server or personal computer. Those skilled in the relevant art will appreciate that the system can be practiced with other computer system configurations, including Internet appliances, hand-held devices, wearable computers, cellular or mobile phones, multi-processor systems, microprocessor-based or programmable consumer electronics, set-top boxes, network PCs, mini-computers, mainframe computers and the like. The system can be embodied in a special purpose computer or data processor that is specifically programmed, configured or constructed to perform one or more of the computer-executable instructions explained in detail below. Indeed, the term computer, as used generally herein, refers to any of the above devices, as well as any data processor.

The system can also be practiced in distributed computing environments, where tasks or modules are performed by remote processing devices, which are linked through a communications network, such as a Local Area Network (“LAN”), Wide Area Network (“WAN”) or the Internet. In a distributed computing environment, program modules or sub-routines may be located in both local and remote memory storage devices. Aspects of the system described below may be stored or distributed on computer-readable media, including magnetic and optically readable and removable computer discs, stored as firmware in chips (e.g., EEPROM chips), as well as distributed electronically over the Internet or over other networks (including wireless networks). Those skilled in the relevant art will recognize that portions of the system may reside on a server computer, while corresponding portions reside on a client computer. Data structures and transmission of data particular to aspects of the system are also encompassed within the scope of the system.

Referring to FIG. 1B, some examples of the system employs a computer 140, such as a personal computer or workstation, having one or more processors 101 coupled to one or more user input devices 102 and data storage devices 104. The computer is also coupled to at least one output device such as a display device 106 and one or more optional additional output devices 108 (e.g., printer, plotter, speakers, tactile or olfactory output devices, etc.). The computer may be coupled to external computers, such as via an optional network connection 105, a wireless transceiver 107, or both.

The input devices 102 may include a keyboard and/or a pointing device such as a mouse. Other input devices are possible such as a microphone, joystick, pen, game pad, scanner, digital camera, video camera, and the like. The data storage devices 104 may include any type of computer-readable media that can store data accessible by the computer 100, such as magnetic hard and floppy disk drives, optical disk drives, magnetic cassettes, tape drives, flash memory cards, digital video disks (DVDs), Bernoulli cartridges, RAMs, ROMs, smart cards, etc. Indeed, any medium for storing or transmitting computer-readable instructions and data may be employed, including a connection port to or node on a network such as a local area network (LAN), wide area network (WAN) or the Internet (not shown in FIG. 1B).

Aspects of the system may be practiced in a variety of other computing environments. For example, referring to FIG. 1C, a distributed computing environment with a web interface includes one or more user computers 150 in a system 150 are shown, each of which includes a browser program module 154 that permits the computer to access and exchange data with the Internet 160, including web sites within the World Wide Web portion of the Internet. The user computers may be substantially similar to the computer described above with respect to FIGS. 1A and/or 1B. User computers may include other program modules such as an operating system, one or more application programs (e.g., word processing or spread sheet applications), and the like. The computers may be general-purpose devices that can be programmed to run various types of applications, or they may be single-purpose devices optimized or limited to a particular function or class of functions. More importantly, while shown with web browsers, any application program for providing a graphical user interface to users may be employed, as described in detail below; the use of a web browser and web interface are only used as a familiar example here.

At least one server computer 170, coupled to the Internet or World Wide Web (“Web”) 160, performs much or all of the functions for receiving, routing and storing of electronic messages, such as web pages, audio signals, and electronic images. While the Internet is shown, a private network, such as an intranet may indeed be preferred in some applications. The network may have a client-server architecture, in which a computer is dedicated to serving other client computers, or it may have other architectures such as a peer-to-peer, in which one or more computers serve simultaneously as servers and clients. A database 180 or databases, coupled to the server computer(s), stores much of the web pages and content exchanged between the user computers. The server computer(s), including the database(s), may employ security measures to inhibit malicious attacks on the system, and to preserve integrity of the messages and data stored therein (e.g., firewall systems, secure socket layers (SSL), password protection schemes, encryption, and the like).

The server computer 170 may include a server engine 190, a web page management component 192, a content management component 194 and a database management component 196. The server engine performs basic processing and operating system level tasks. The web page management component handles creation, and display or routing of web pages. Users may access the server computer by means of a URL associated therewith. The content management component handles most of the functions in the embodiments described herein. The database management component includes storage and retrieval tasks with respect to the database, queries to the database, and storage of data such as video, graphics and audio signals.

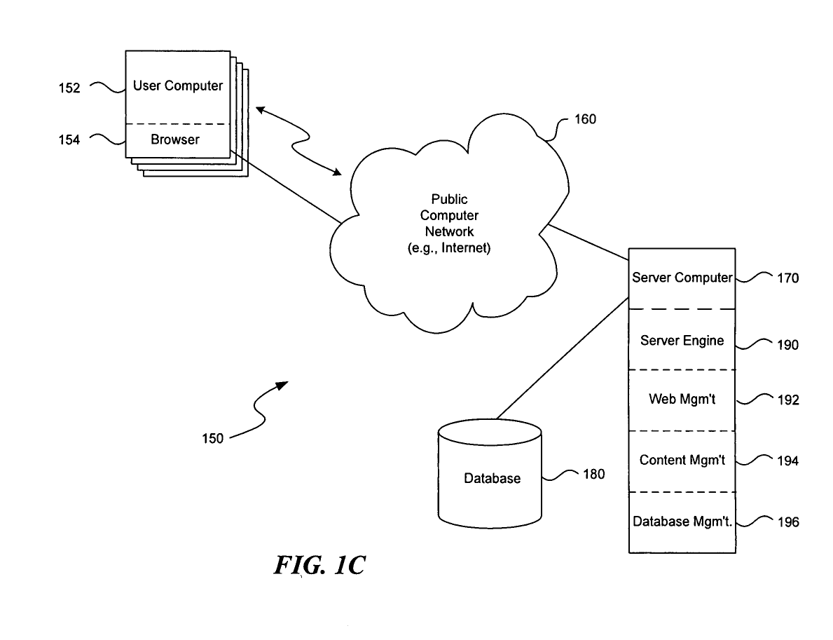

Referring to FIG. 2, a block diagram illustrating components of a user controlled entertainment system 200 is shown. The system 200 includes a control device 210, such as the hand-held or hand-attached devices described herein. Furthermore, the system includes a character display device 220, such as a computing system and monitor. The character display device includes a reception component 222 that receives information, such as motion information, from the control device 210. For example, the reception component may receive information over a wired communication link 230 or a wireless communication link 232. The character display device also includes a motion estimation component 224 that determines, estimates, and/or predicts parameters for the motion of the control device 210, a character control component 226 that uses the determined parameters to control a displayed character, and a display component 228 that displays the character to the user. Further details regarding the operation of these components will be described herein.

### Functionality of the User Control Device

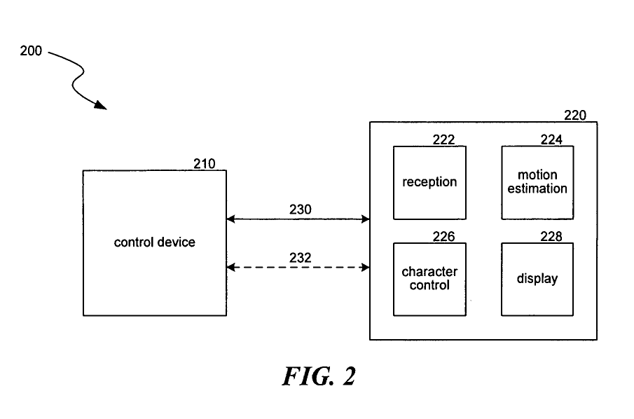

As described herein, the control device may include accelerometers that sense, measure, or otherwise track the motion of the device and output measured values that are used to estimate, predict, and/or determine the acceleration and relative motion of the control device. Referring to FIG. 3, a block diagram illustrating a user control device 300 for use within the user controlled entertainment system is shown. The control device 300 includes a triaxial accelerometer 310 which measures acceleration in three orthogonally oriented axes. The triaxial accelerometer 310 may be oriented to match the X, Y, and Z axes of a housing that contains the device, or may be oriented based on other factors. Additionally, although control device 300 utilizes three accelerometer axes, the device may alternatively utilize one or two accelerometer axes, depending on the needs of the system and/or user. The device may convert raw acceleration measurements to digital form using an analog-to-digital converter, or ADC, 320 and output the digital measurements from the device 300 via a transmitter 330 to a computing system that displays a graphical object to a user of the control device 300.

For example, the device 300 may transmit the digital measurements over a data bus 340, such as wired data bus (e.g., a USB connection). Alternatively, the device 300 may transmit the digital measurements over a radio frequency wireless connection (e.g., Bluetooth, Zigbee, and so on). In some cases, the device may perform any processing of the raw acceleration measurements at the computing device by transmitting the raw measurements to an ADC within the computing device (not shown).

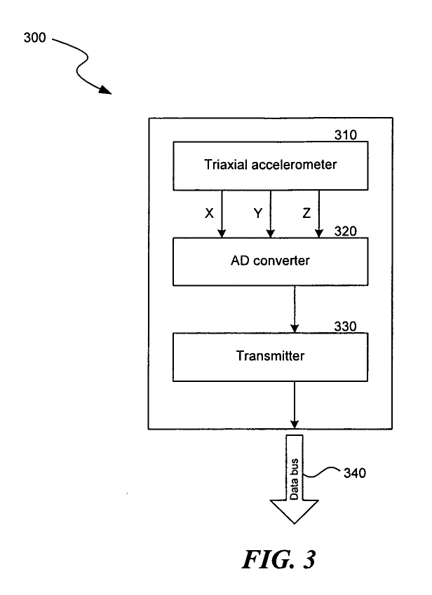

Referring to FIG. 4, a block diagram illustrating the user control device 300 in greater detail is shown. The device 300 includes a triaxial accelerometer 310 having acceleration axes 410, 412, and 414, such as a MEMS accelerometer with signal conditioning (such as the Analog Devices ADXL330). The accelerometer 310 may measure up to 3 G in 3 orthogonal axes and may have a bandwidth of 1600 Hertz or more. Furthermore, the device 300 may include one or more low-pass filters 420, 422, and 424 to reduce signal noise from a power supply (not shown) and other sources. The device 300 transmits the output of the low-pass filters 420, 422, and 424 to analog-to-digital converters 320. For example, the analog-to-digital converters may be 10 bit, 0 to 3.3 volt devices contained within a microcontroller 430, manufactured by Microchip System Inc, or may be discrete components as shown in the Figure. The analog-to-digital converters 320 convert analog output signals from each accelerometer axis (X, Y and Z) into digital acceleration values. The microcontroller 430 combines the three axes of data into a data frame, and outputs the data frame to the computing system, such as over a data bus 340. For example, the microcontroller 430 may output a data frame that is 8 bytes long, having 2 bytes for each accelerometer axis, 1 header byte and 1 tail byte for synchronization. Although the control device 300 is described employing one or more accelerometers other sensors be used, such as angular rate sensors, magnetometers, and so on.

### Functionality of a Presentation Control Device

As described herein, a presentation control device may receive information (such as motion data) from a control device 300 that is attached or held by a user during self-stimulation. The presentation device may employ a component that estimates the motion of the control device 300 from the received information. For example, the component may receive static and dynamic acceleration values and calculate a parametric hand motion value for each control device axis (representing the position and/or inclination of the device in each axis).

In some cases, the presentation device may first preprocess the received information (such a received data frame) by applying a gravity normalization function and scaling function to the data frame. The gravity normalization function may use a high-pass filter to filter acceleration data above and below a predetermined cut-off frequency. For example, any acceleration below the cut-off frequency may be static acceleration due to gravity, whereas any data above the cut-off frequency may be dynamic acceleration. The dynamic acceleration may represent the acceleration due to a change in velocity of the control device along one, two, or three orthogonal axes. The high-pass filter used to separate static and dynamic acceleration in gravity normalization function 76 may be a standard moving average filter or may use a complex scheme, such as by employing a Kalman filter.

After filtering, the scaling function converts the acceleration values from analog-to-digital converter units to acceleration units in terms of meters per second squared.

The system may employ other methods and algorithms to separate the raw accelerometer data into dynamic acceleration values and static acceleration values. The system may choose an algorithm based on computational simplicity, processing speed, and so on. One such method uses a Kalman filter to estimate the inclination of the control device, based on estimates regarding the frequency content of measured acceleration samples. If three axes of angular rate sensor data are received from the control device, the system may also estimate the inclination of the control device.

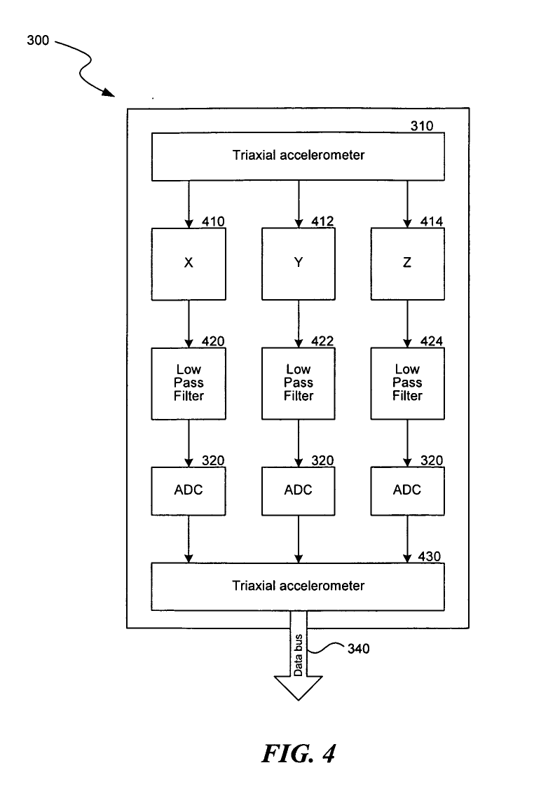

Referring to FIG. 5, a block diagram illustrating components of a motion estimation component 500 used by the computing device is shown. The motion estimation component 500 may include a (dynamic) acceleration values reception component 510 and a parametric values output component 520. The system may transmit dynamic acceleration values for each axis of the control device to the acceleration values component 510 in an iterative fashion, because the values may be first pre-processed. The dynamic acceleration values indicate acceleration due to the motion of the control device 30 in each axis of acceleration.

A numerical integrator component 520 may store a current or baseline position and velocity for every axis of motion of the control device, and may update the position and velocity by integrating the received dynamic acceleration values using a pre-determined numerical integration method, such as Verlet or Euler integration. The component 500 may then transmit the position and velocity data from the numerical integrator component 520 to a scaling function component 530 that scales the data, such as by multiplying the input position values for some or every axis by a pre-determined factor to increase or decrease the sensitivity to motion of the control device 300. Next, a damping function component 540 receives the scaled values and damps a scaled value of some or all axes when the scaled value exceeds a predetermined minimum or maximum position value (such as by use of a simple damped mass-spring system). Similarly, a cropping function component 550 crops any damped values that exceed a minimum or maximum position value. For example, a minimum cropping value is zero, and a maximum value is one. Thus, the output of the cropping function component 550 is a parametric value for every axis of motion of the control device. Additionally, a favored value function component 560 may alter one or more of the cropped values (such as by a simple damped mass-spring system) to favor a pre-determined positional value. In some cases, values are altered to further mimic the motion of the control device. For example, the system may expect the control device to repeatedly return to the same position during the cyclical motion of sexual self stimulation. The extent to which the position is weighted toward the pre-determined position in each axis can be controlled by a predetermined spring constant and damping factor for each axis. The favored position function component 560 determines a parametric hand motion value for each axis and outputs the value to the parametric values output component 520, which may then transmit the value to a component used to control a displayed character.

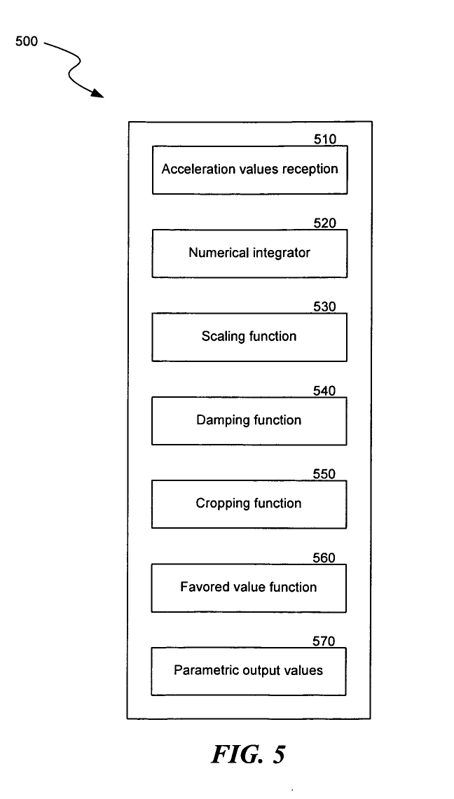

Referring to FIG. 6, a block diagram illustrating components of an alternative motion estimation component 600 used by the computing device is shown. The motion estimation component 600 may include a (static) acceleration values reception component 610 and a parametric values output component 620. The acceleration values reception component 610 may receive static acceleration values that indicate acceleration due to gravity, and therefore indicate the inclination of a control device relative to a gravity vector. An inclination calculation component 630 may then compute, calculate, and/or determine the angle of the control device relative to gravity based on various pre-determined functions. For example, the inclination angle component 630 may calculate inclination as follows:

inclination=acos(v_{gravity}•v_{static acceleration})

where v_{gravity} indicates the vector [0,1,0], and remains constant, and v_{static acceleration} is the vector composed of each axis that measures static acceleration values. The output inclination is the current inclination angle of the control device relative to gravity.

Next, a moving average filter component 640 receives the calculated inclination angle and computes the mean of the last M computed inclination angles, where M is a pre-determined value. When the window of inclination samples represented by M is large enough and the motion of the control device is cyclical, the mean inclination value may roughly represent a center or default inclination angle of the control device. A mean inclination corrector component 650 inputs receives the default inclination angle and subtracts it from the calculated inclination angle to produce a corrected current inclination angle. A bias and scaling function component 660 may receive the corrected current inclination angle and scale the angle by a pre-determined amount or may add a predetermined bias value to the angle. Additionally, a favored value function component 670 may received the corrected, biased, and/or scaled angle and may alter the angle to favor a predetermined inclination angle. The favored value function component 670 determines a parametric hand motion value for all axes and outputs the value to the parametric values output component 620, which may then transmit the value to a component used to control a displayed character. In some cases, there is only one final inclination angle and the parametric hand motion value for each axis are all the same inclination angle value.

As described herein, the system transmits the determined parametric values to a character control component that controls a character displayed to a user of the control device.

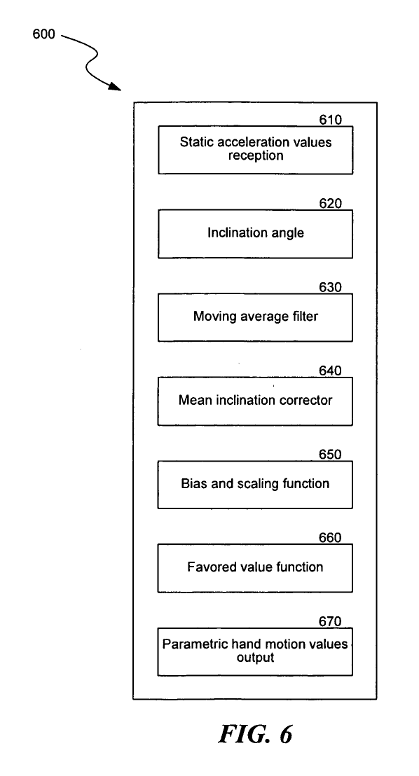

Referring to FIG. 7, a block diagram illustrating a character control component 700 is shown. The character control component 700 includes a hand motion frequency and intensity tracking system 710, an emotion and behavior control system 720, and an animation parameter control system 730. The hand motion frequency and intensity tracking system 710 receives the parametric values from the motion estimation component 500 and/or 600 and determines values related to a hand motion frequency and/or intensity. The emotion and behavior control system 720 receives the hand motion frequency and intensity values and alters the actions, behavior and emotions of an on-screen character. The animation parameter control system 730 may also receive the parametric values from the motion estimation components 500 and/or 600 and may directly apply one or more of the parametric values to various animation parameters of the on-screen character, such as by adjusting a displayed frame.

Video games typically use multiple, short sequences of frames to depict an animated character engaging in different actions or behaviors. The displayed frame can be either a pre-recorded two-dimensional set of static images, or a three-dimensional character model animated and rendered in real time. One such action used commonly in erotic video games would consist of a female character and a male character engaging in sexual intercourse, depicting a thrusting motion of the male's hips. The animation parameter control system 730 may use the received parametric values to choose a frame to display in a short sequence of frames depicting an on-screen character engaging in sexual action.

For example, a parametric value of zero would display the first frame of the sequence, while a parametric value of one would display the last frame of the sequence. Any parametric hand motion value in between zero and one would act as a linear interpolation parameter, thereby selecting a frame between the first and last frame of the animated sequence. As the user performs a cyclical motion of self stimulation, one or more of the parametric hand motion values will generally vary from zero to one and back to zero, in a cyclical manner. In some cases, one of the parametric hand motion values may be multiplied by the number of animated frames to choose the current frame to be displayed. The displayed frame will change accordingly to match the on-screen character's motion with the motion of the user's hand.

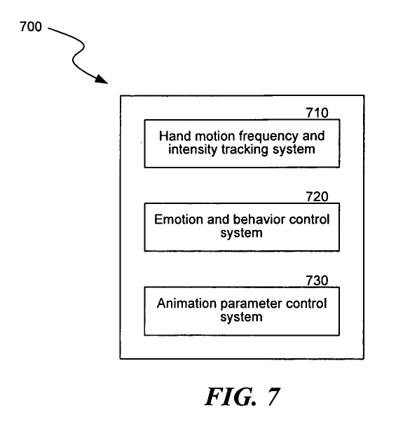

Referring to FIG. 8, a table 800 relating the position of a user's hand, a corresponding parametric value for one axis of movement, and a displayed character frame is shown.

Each row in the table shows the position 810 of a male user's hand on his penis during masturbation, the corresponding parametric hand motion value of one axis 820, and the resulting frame 830 to be displayed. When the male user's hand moves in a cyclical manner during masturbation, the frame sequence will play forward and backward in a cyclical manner, thus providing the user direct control over a displayed character's motion. It should also be noted that although a male user is described engaged in sexual self-stimulation in table 800, a similar table may be employed that relates the position of a female hand when engaging in masturbation or other types of self-stimulation.

Additionally, The system may evaluate motion, such as cyclical motion, through the tracking of gestures. For example, the system may provide certain displayed character behaviors based on detecting gestures performed by the user. The system may use a variety of gesture tracking methods, including the Hidden Markov Model and via training sample data. For example, one or more axes of the accelerometer sample data can be used as training input, and a gesture tracking algorithm may be used to detect a characteristic motion of the user's hand. Thus, gesture tracking may be used to determine the frequency of a cyclical motion, among other things.

In some examples, the system displays a character as a three dimensional model rendered in real time. In these cases, the animation parameter control system 730 may also directly modify translations and rotations of various parts of the displayed character. Video game characters may be controlled by a hierarchical skeleton comprised of joints. Altering a joint's rotation or translation will cause a part of the 3D character to move or rotate. The animation parameter control system 730 may scale one of the parametric hand motion values by a pre-determined factor and apply it as a rotation or translation to a joint of the 3D character. For example, one axis of a parametric hand motion value may be scaled and applied to the translation of a dildo object on the screen. As the parametric hand motion value varies, so will the translation of the dildo object on the screen.

The animation parameter control system 730 may also use the parametric hand motion values to control the position of an on-screen icon or cursor object. For example, an erotic video game may display a female character, and a cursor representing a hand may be moved around the screen. The received parametric values may directly control the X and Y coordinates of the cursor on the screen to enable the user to control the cursor's position on the screen based on the motion of his/her hand. Additionally, in cases where the control device includes a button or other pressable input, the user may employ the control device to move the cursor and select an object on the screen. The animation parameter control system 730 may then receive parametric values that relate to the control device movement and the pressing of a button, and cause the on-screen cursor to move to and select displayed objects on the screen.

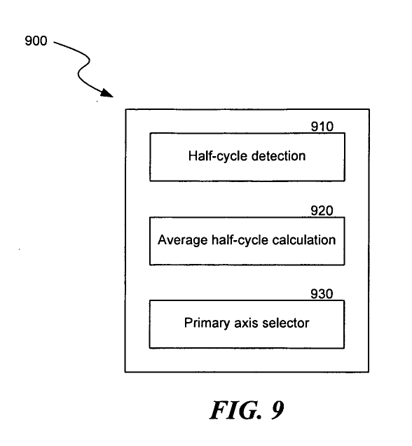

Referring to FIG. 9, a block diagram illustrating components of the hand motion tracking system 710 is shown. The hand motion tracking system includes a Half-cycle detection component 910 that receives parametric hand motion values for each axis and monitors the values for minimum and maximum quantities. In some cases, each axis of parametric hand motion value data is monitored separately. When a half-cycle of minimum to maximum value is detected for a certain axis, the half-cycle amplitude can be determined by subtracting the minimum from the maximum. The half-cycle's amplitude, duration, and the time at which the minimum value half-cycle ended may be stored for that axis. An average half-cycle calculation component 920 may calculate the average half-cycle duration for each axis and the average half-cycle amplitude for each axis of all half-cycles which ended in the last N seconds, where N is a pre-determined time duration. In some cases, the average half-cycle calculation component 920 uses a moving average filter or other averaging function to perform the calculations. The average half-cycle duration value for each axis may be scaled by a pre-determined value and inverted at a duration scaling and inversion function to produce an average full-cycle frequency for each axis. The average half-cycle amplitude may be scaled by a pre-determined value using an amplitude scaling function to produce the average full-scale amplitude. A primary axis selector component 930 selects a primary axis of control device data based on a pre-determined algorithm. For example, the primary axis may be selected and never change for a device. In some cases, it may be selected based on the magnitude of frequency or amplitude of each axis, or any other pre-determined set of parameters and algorithms. After the primary axis is selected, primary axis selector component outputs the average full-scale frequency of the primary axis as the hand motion frequency and the average full-cycle amplitude of the primary axis as the hand motion intensity.

In some cases, the hand motion tracking system 710 may generate the output hand motion frequency from a weighted average of the primary axis and non-primary axis average full-scale frequency values. Similarly, the hand motion tracking system 710 may generate the output hand motion intensity from a weighted average of the primary axis and non-primary axis average full-scale amplitude values. The weights for each axis may be changed over time based on a pre-determined algorithm, and the output values may be filtered to provide a smoother, less granular output. Of course, other functions and algorithms may be used to generate frequency and intensity values, such as time to frequency domain transformations (e.g., Fast Fourier Transform), wavelet transformations, and so on.

In addition, the frequency and intensity tracking system 710 may receive raw or pre-processed acceleration values and determine the intensities and frequencies of motion using similar methods.

Often, behavior and character emotion systems in video games are represented by one or more event-driven finite state machines. In some cases, the emotion and behavior control system 1720 includes a character behavior and emotion state machine. Each state in the character behavior and emotion state machine may have an associated series of animated frames depicting a behavior, action, or emotion of a character, which may be displayed on a screen upon state entry. For example, one state may be associated with animated frames depicting the character engaging in sexual self-stimulation. Another state may be associated with animated frames depicting the character engaging in oral sex with another character. Another state may be associated with animated frames depicting the character standing and relaxing with a smile on her face. Yet another state may be associated with animated frames depicting the character standing with a frown on her face, while tapping her foot, indicating impatience. Additionally, each state may be associated with a clip of audio, which may be played audibly upon state entry. The audio clips may sync or be related to the behavior or displayed emotions of the character. For example, audio clips may present sounds including conversational dialog, laughing, moans of pleasure, gasps, and so on, with or without a related displayed content.

Events within the system may be triggered by the output of the hand motion frequency and intensity tracking system 710. For example, a state change may be triggered when a hand motion frequency value exceeds a pre-determined minimum or maximum frequency value for a pre-determined period of time. For example, in a certain state, the on-screen character may be displayed with a placid look on her face, engaging in sexual intercourse with another character at a slow rate. In this example, if the hand motion frequency increases to a frequency above a threshold value for at least three seconds, the state may change to a new state, in which the character is depicted with a more intense facial expression, engaging in sexual intercourse with another character in a different sexual position, at a faster rate. A similar type of state change may be triggered when the hand motion intensity value reaches or exceeds a pre-determined minimum or maximum intensity value for a pre-determined period of time.

A state change may also be triggered when the hand motion frequency generally matches a predetermined frequency value for a pre-determined period of time. For example, in a certain state, the on-screen character may be displayed in a relaxed pose, engaging in sexual self-stimulation at a slow, predetermined cyclical rate (such as 60 Hz). In this example, if the hand motion frequency remains within a similar range (such as between 50 Hz and 70 Hz for at least ten seconds), a new state may be entered in which the character is displayed with a happy facial expression, and congratulates the user through audible dialog. A similar type of state change may be triggered when the hand motion intensity generally matches a pre-determined intensity value for a pre-determined period of time.

A state change may also be triggered when a predetermined number of hand motion full cycles are complete, as recorded by the frequency and intensity tracking system 710. Of course, other triggers are possible. For example, gestures may trigger a state change. A gesture tracking system, such as those based on the Hidden Markov Model and a set of training data may be used to determine when a gesture is performed using data samples from one or more axes of the accelerometer taken as input. When a gesture is detected, a state change may be triggered in the character behavior and emotion state machine.

Additionally, although the emotion and behavior control system 720 is represented using a finite state machine system, it could employ any non-state-based system to control the emotion and behavior of the on-screen character.

### Examples of the Control Device

As described herein, the control device may be held in a user's hand, attached to a user's hand (or proximate to a user's hand), or may be attached to or contained within a sexual apparatus. The following examples show various configurations of the control device, although others are of course possible.

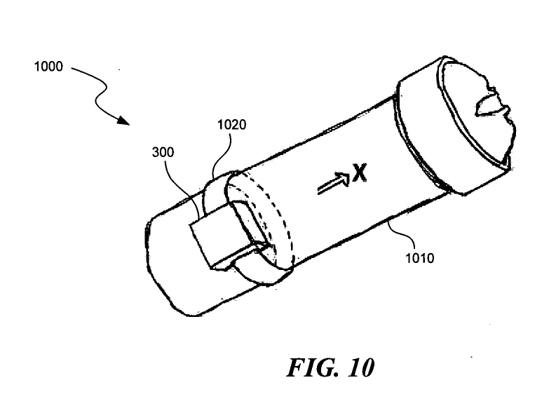

Referring to FIG. 10, a schematic diagram of the user control device 300 attached to a male self-stimulation apparatus 1000 is shown. The device 300 may be attached to a cylinder 1010 by a strap 1020, other attachment mechanisms, or may be integrated into the apparatus. In some cases, the control device 300 is attached to generally align the X-axis of the device with the long axis of the cylinder, as shown. As the male user slides the cylinder 1010 over his penis, the control device 300 will measure acceleration due to movement of the cylinder.

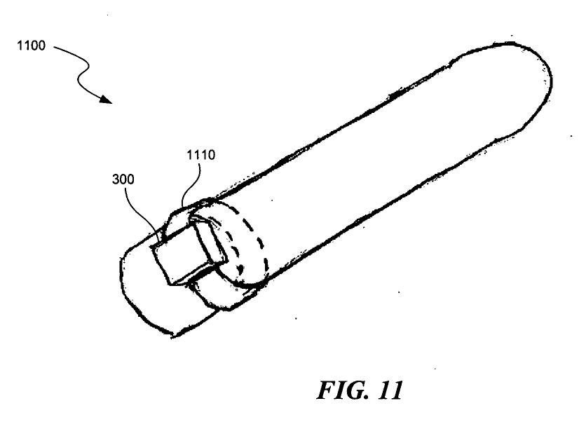

Referring to FIG. 11, a schematic diagram of the user control device 300 attached to a female self-stimulation device 1100 is shown. The control device 300 may be attached to a device 1100 (such as a dildo) by a strap 1110 or other attachment mechanism, such that the control device's X-axis generally aligns with the long axis of the self-stimulation device 1100, as shown. The use of a strap to attach the control device 300 to the self-stimulation device 1100 allows the use of the control device 300 with any number of commercially available self-stimulation devices and also allows the user to remove the device when it is not desired.

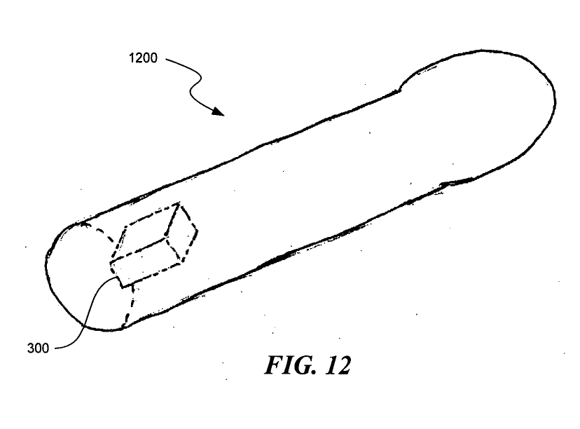

Referring to FIG. 12, a schematic diagram of the user control device 300 embedded within a female self-stimulation device 1200 is shown. In some cases, the control device 300 may be embedded within a self-stimulation device 1200, such as a dildo. For example, a user may not wish to see or make contact with the control device 300, as it may be disruptive to the experience of the user.

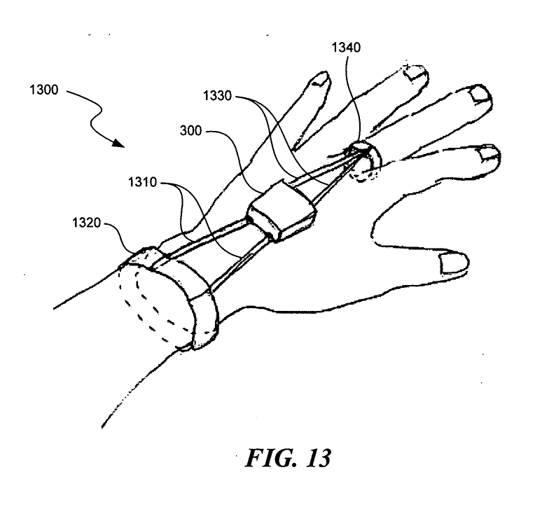

Referring to FIG. 13, a schematic diagram 1300 of the user control device 300 attached to a user's hand is shown. In this example, the control device 300 is attached to the back of the user's hand via a plurality of straps and a wrist band. One end of the control device 300 is attached via one or more straps 1310 to a wrist band 1320 worn on the user's wrist. The other end of the control device 300 is attached via one or more straps 1330 to a ring 1340 on the user's finger.

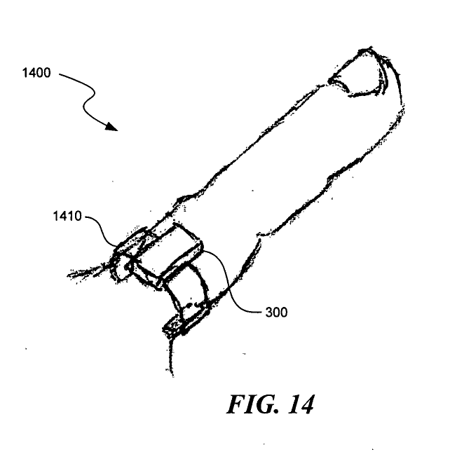

Referring to FIG. 14 a schematic diagram of the user control device 300 attached to a user's finger is shown. In this example, the control device 300 is rigidly attached to a ring 1410 worn on the user's finger.

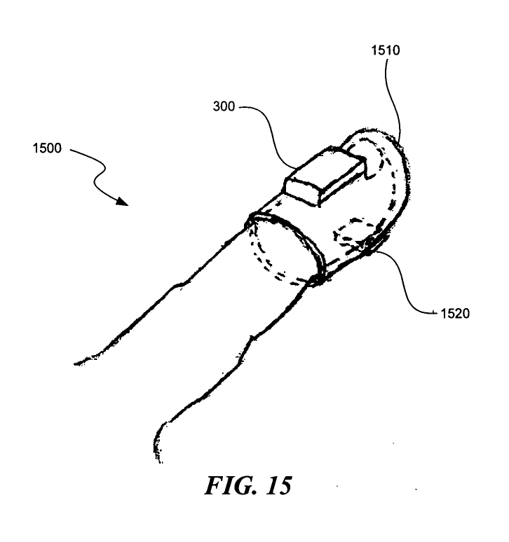

Referring to FIG. 15, a schematic diagram 1500 of the user control device 300 attached to a user's fingertip is shown. In this example, the control device 300 is attached to the fingertip via a shroud 1510 such that the control device 300 resides upon the dorsal side of the distal phalanx when the fingertip shroud 1510 is placed over the fingertip. A pressure sensing button 1520 may be attached to the fingertip shroud 1510 such that the button resides upon the ventral side of the distal phalanx when the fingertip shroud 1510 is placed over the fingertip. Placed in such a manner, the button may be pressed by a pinching motion between the user's finger and the user's thumb. Pressing of the button may cause a displayed character to perform additional behaviors not normally performed due to the motion of the control device 300.

In some cases, the pressure sensing button could be replaced by or used along with one or more capacitive touch sensors. The system may use output received from the capacitive touch sensors in a similar manner as the switch or pressure sensing button, such as to provide additional control and/or interaction with the on-screen character.

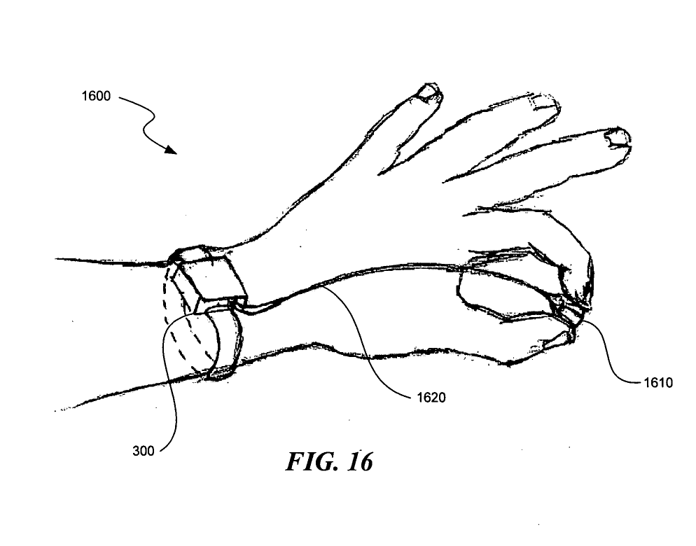

Referring to FIG. 16, a schematic diagram of the user control device 300 having a dynamic user input component 1610 is shown. In this example, the control device 300 communicates with an input component 1610, such as a pressable button attached to the control device 300 via a wired tether 1620 (or other wired or wireless links). The pressure sensing button 1610 may be squeezed between a fingertip and the thumb to provide pressure data. Pressing of the button may control additional displayed behaviors of an on-screen character in addition to those controlled by movement of the control device 300.

Of course, other configurations not shown may be used to attach the control device 300 to the user's hand, wrist, finger, thumb, palm, or other portion of the user's extremity. The control device 300 may be attached or integrated in a full or partial glove, attached to a sport or fashion wrist band, or may be attached to the user's skin by a disposable or reusable adhesive strip. Although shown as box-like, the control device 300 may assume any shape, and may be disposed within a housing constructed of any material. The control device may be contained by a cell phone or other such device which provides acceleration sensor data in certain embodiments of the present system.

Aspects of the system provide a method for both females and males to control the motion, type of behavior, and/or attributes of an on-screen graphical character based on the motion of the hand, such as motion during sexual self-stimulation.

### CONCLUSION

A hand-held or hand-attached computer control device, in some cases accelerometer-based, is utilized to control graphical objects in a computer-driven display in which the motion, type of behavior, and attributes of the graphical object are controlled through movement and resulting accelerations of the control device, such that the individual is provided with computer control during sexual self-stimulation without the requirement of a mouse or similar pointing device to provide positional input.

In general, the detailed description of embodiments of the system is not intended to be exhaustive or to limit the system to the precise form disclosed above. While specific embodiments of, and examples for, the system are described above for illustrative purposes, various equivalent modifications are possible within the scope of the system, as those skilled in the relevant art will recognize. For example, while processes or blocks are presented in a given order, alternative embodiments may perform routines having steps, or employ systems having blocks, in a different order, and some processes or blocks may be deleted, moved, added, subdivided, combined, and/or modified. Each of these processes or blocks may be implemented in a variety of different ways. Also, while processes or blocks are at times shown as being performed in series, these processes or blocks may instead be performed in parallel, or may be performed at different times.

These and other changes can be made to the system in light of the above Detailed Description. While the above description details certain embodiments of the system and describes the best mode contemplated, no matter how detailed the above appears in text, the system can be practiced in many ways. Details of the system may vary considerably in its implementation details, while still being encompassed by the system disclosed herein. As noted above, particular terminology used when describing certain features or aspects of the system should not be taken to imply that the terminology is being redefined herein to be restricted to any specific characteristics, features, or aspects of the system with which that terminology is associated. In general, the terms used in the following claims should not be construed to limit the system to the specific embodiments disclosed in the specification, unless the above Detailed Description section explicitly defines such terms. Accordingly, the actual scope of the system encompasses not only the disclosed embodiments, but also all equivalent ways of practicing or implementing the system.

We claim:

1. A system for controlling a sexually explicit presentation viewed by a user when the user is performing self stimulation, the system comprising:
a user control device associated with the user that detects movement of a hand of the user during the self stimulation; and
a presentation controller that receives signals from the user control device indicative of the detected movement of the hand and generates signals that cause an adjustment to a sexually explicit presentation viewed by the user.

2. The system of claim 1, wherein the user control device associated with the user is attached to the user proximate to the hand of the user and measures movement of the hand by tracking an acceleration of the user control device.

3. The system of claim 1, wherein the user control device associated with the user is configured to be held in the hand of the user and measures movement of the hand by tracking an acceleration of the user control device.

4. The system of claim 1, wherein the presentation controller receives information from the user control device related to a relative position of the hand of the user and adjusts the sexually explicit presentation based on the relative position information.

5. The system of claim 1, wherein the presentation controller receives information from the user control device related to an intensity of movement of the user control device and adjusts the sexually explicit presentation based on the intensity of movement.

6. The system of claim 1, wherein the presentation controller receives information from the user control device related to a frequency of motion of the user control device and adjusts the sexually explicit presentation based on the frequency information.

7. The system of claim 1, wherein the presentation controller receives information from the user control device related to an inclination angle of the user control device and adjusts the sexually explicit presentation based on the inclination angle information.

8. A computer-readable medium containing executable instructions that cause a computing system to perform a method of presenting sexually explicit images viewed by a user, the method comprising:
receiving information from an acceleration sensor that moves in relation to movement of a hand of a user when the user is masturbating;
estimating the movement of the hand of the user based on the received information; and
directing the presentation of a sexually explicit image in response to the estimated movement.

9. The computer-readable medium of claim 8, wherein estimating the movement includes calculating a parametric value for the movement of the hand of the user.

10. The computer-readable medium of claim 8, wherein estimating the movement includes determining an intensity and frequency of the movement of the hand of the user.

11. The computer-readable medium of claim 8, wherein the user is a male user and wherein estimating the movement includes identifying a position of the hand of the user relative to the user's penis.

12. The computer-readable medium of claim 8, wherein estimating the movement includes calculating an angle of inclination of the acceleration sensor.

13. The computer-readable medium of claim 8, further comprising:
receiving additional information from the acceleration sensor that indicates altered movement of the hand of the user;
estimating the different movement of the hand of the user; and
directing the presentation of a different sexually explicit image in response to the estimated different movement.

14. The computer-readable medium of claim 8, wherein directing the presentation of a sexually explicit image includes transmitting instructions to a display device that alter a configuration of a displayed three dimensional graphical object.

15. The computer-readable medium of claim 8, wherein directing the presentation of a sexually explicit image includes transmitting instructions to a display device that adjust a real-time dynamically determined configuration of a displayed three dimensional graphical object.

16. The computer-readable medium of claim 8, wherein directing the presentation of a sexually explicit image includes:
selecting a frame from a group of frames related to the sexually explicit image, wherein the frame is associated with the estimated movement; and
directing a display device to display the selected frame to the user.

17. An apparatus used to track motion of a hand of a user performing self stimulation when viewing a displayed sexually explicit presentation; comprising:
a housing;
an acceleration sensor contained within the housing for generating measurements associated with the movement of the housing; and
a transmission component that receives the generated measurements taken by the acceleration sensor and transmits the received measurements to a controlling device associated with a sexually explicit presentation in order to alter the presentation in accordance with the motion of the housing.

18. The apparatus of claim 17, wherein the housing is configurable to be wearable by the user proximate to a hand used during the performed self stimulation.

19. The apparatus of claim 17, wherein the housing is configurable to be used as a sexual stimulation device.

20. The apparatus of claim 17, further comprising:
an input device that receives input from the user, wherein the transmission component transmits the received input to the computing device associated with the sexually explicit presentation in order to alter the presentation.
